(19) United States
(12) Patent Application Publication
(10) Pub. No.: US 2003/0199649 A1
(43) Pub. Date: Oct. 23, 2003

(54) Method and apparatus for the controlled dilution of organometallic compounds

(76) Inventors: David Robert Orbison, Prenton (GB); Philip James Hardwick, Warrington (GB); James Samuel Birch, Frodsham (GB)

Correspondence Address: MYERS BIGEL SIBLEY & SAJOVEC, PO BOX 37428, RALEIGH, NC, 27627, US

(21) Appl. No.: 10/395,538

(22) Filed: Mar. 24, 2003

Related U.S. Application Data
(60) Provisional application No. 60/367,652, filed on Mar. 26, 2002.

(51) Int. Cl. C08F 4/44

(52) U.S. Cl. 526/123.1

(57) ABSTRACT

An apparatus and method for allowing the industrial use of a high-concentration supply of an organometallic composition, such as an alkyllithium composition, with processes requiring low-concentration organometallic feeds by blending a supply of organometallic with a supply of hydrocarbon solvent, analyzing the concentration of organometallic within the blend using spectroscopic analysis to determine the concentration of organometallic, communicating the concentration value to a control apparatus which compares the actual concentration value with a previously determined desired concentration value and, adjusting the rate of supply of the organometallic, the rate of supply of the hydrocarbon solvent, or the rate of supply of both the organometallic and the solvent to obtain a blended organometallic stream of the desired concentration.

### RELATED APPLICATIONS

This application claims priority from U.S. Provisional Application Ser. No. 60/367,652, filed 26Mar. 2002, the disclosure of which is hereby incorporated herein in its entirety.

### FIELD OF THE INVENTION

The invention relates to a chemical process control system and method for monitoring and controlling the concentration of an alkyllithium feed solution to an industrial process.

### BACKGROUND OF THE INVENTION

Organometallic compounds such as alkyllithium compounds are widely used in industry as precursors, initiators, and catalysts for the formation of a variety of products. For instance, butyl lithium compounds are used as polymerization initiators and as strong bases for organic synthesis.

N-butyl lithium is the most widely used initiator for anionic polymerization, and is used in the production of polymers such as styrenic thermoplastic elastomers and random styrene-butadiene rubber solution polymers for use in automobile tires. N-butyl lithium is also used as a strong base in organic synthesis to improve yields and throughput of reactions, with particular effectiveness in deprotonation and metal-halogen exchange reactions. Sec-butyl and tert-butyl lithium compositions are also used as polymerization initiators and strong bases for organic synthesis, but each of the lithium compounds has slightly different properties than n-butyl lithium.

Many organometallic compositions, particularly alkyllithium compositions, ignite on contact with water. Butyl lithium compounds, for instance, may even ignite upon contact with the moisture found in air. Therefore, extraordinary precautions must be taken during the production, transportation, and storage of organometallic compounds.

Because of their reactivity with water, the organometallic compounds are transported and maintained in a hydrocarbon solution until ready for use. Butyl lithium compositions may be maintained in hydrocarbon solutions such as cyclohexane. The compositions are typically produced in custom concentrations depending on the requirements of the end user, and shipments of the custom concentrations are usually made on a regular basis from the organometallic production site to the end user. Each shipment of organometallic presents safety issues because the organometallic cannot be exposed to water at any point. Further, administrative requirements of legal and environmental authorities accumulate with each shipment.

Because of the burden associated with each shipment of organometallic materials, it is advantageous to ship the organometallics, such as alkyllithium, in high concentrations so as to minimize the volume of each shipment. Alkyllithium, such as butyl lithium, may be shipped in concentrations as high as 95% in hydrocarbon solution. However, industry typically uses the alkyllithiums in concentrations of about 15% to about 19%, and most processes are incapable of handling high-concentration alkyllithium compositions.

### SUMMARY OF THE INVENTION

The invention is an apparatus and method for allowing the industrial use of a supply of organometallic compositions, particularly alkyllithium compositions, with processes requiring low-concentration organometallic feeds. The invention accepts a feed of concentrated organometallic solution and selectively dilutes the concentrated feed by controlled dilution of the feed with a solvent to produce an organometallic stream of a reduced concentration.

When used with alkyllithium, the invention blends a supply of alkyllithium solution with a supply of hydrocarbon solvent. The concentration of alkyllithium within the blend is analyzed using spectroscopic analysis and the measured or calculated concentration of alkyllithium is determined. The concentration value is communicated to a control means which compares the actual concentration value with a previously determined desired concentration value and, based upon the difference in the determined and desired concentration values, adjusts the rate of supply of the alkyllithium solution, the rate of supply of the hydrocarbon solvent, or the rate of supply of both the alkyllithium solution and the solvent.

### BRIEF DESCRIPTION OF THE DRAWINGS

Having thus described the invention in general terms, reference will now be made to the accompanying drawings, which are not necessarily drawn to scale, and wherein:

FIG. 1 is a side cutaway view of a first embodiment of a spectroscopic cell for use with the invention;

FIG. 2 is a side cutaway view of a second embodiment of a spectroscopic cell for use with the invention;

FIG. 3 is a schematic diagram of an embodiment of the invention used for in-line dilution of an alkyllithium solution; and

FIG. 4 is a schematic diagram of another embodiment of the invention used for control of concentration of an alkyllithium solution in a vessel.

FIG. 5 is a schematic diagram of an additional embodiment of the invention used to control the production of an alkyllithium stream, with concentrated alkyllithium being supplied from an ISO tanker.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The various components of the instant invention may be arranged in a number of different ways, each of which accomplish the main object of the invention, i.e. to supply a consistent and precise concentration of an organometallic in a hydrocarbon solvent.

Each of the embodiments below exemplifies a system which, in some manner, does the following: supply a flow of hydrocarbon solvent, supply a flow of an organometallic composition which is preferably an alkyllithium composition in a hydrocarbon medium, mix the organometallic with the solvent in order to dilute the organometallic solution, quantitatively measure the properties of the diluted organometallic solution using spectroscopic analysis, and using a process control to vary one or more of the parameters of the system based upon the results of the spectroscopic analysis to obtain a desired quantitative aspect of the blended organometallic which is released from the system. The details of the invention will be expressed with respect to alkyllithium components specifically though the invention is equally applicable to organometallic compositions.

Various hydrocarbon solvents are used with the invention. In general, a first hydrocarbon solvent or mixture of solvents is supplied in pure or nearly pure form for use in diluting a stream of alkyllithium solution. The alkyllithium solution to be diluted is supplied as a solution of alkyllithium with a second hydrocarbon solvent, which may also be a mixture of solvents. For ease of description, the solvent, which is pure or nearly pure, is simply described as the “hydrocarbon solvent”. The hydrocarbon solvent that holds the alkyllithium in solution is referred to as the “hydrocarbon medium”. In a circumstance where both solvents contain alkyllithium, the solvent containing the lower concentration of alkyllithium is referred to as the “hydrocarbon solvent”.

A supply of hydrocarbon solvent is provided to the invented system and may be any of a wide number of hydrocarbon compounds typically used as solvents which are preferably liquid between the processing temperatures of from about 0° C. to about 80° C., including alkanes, cycloalkanes, and aromatic hydrocarbons. The hydrocarbon solvent may be a mixture of two or more solvents, and the solvent is substantially free of contaminants, such as water and alcohol. As mentioned, water reacts with many organometallic compounds, with a potentially explosive evolution of heat. Alcohols also react with many organometallic compounds. It is therefore necessary that the combined content of water and alcohols be kept below a level of 1000 parts per million (ppm) of the solvent.

Exemplary hydrocarbon solvents are cyclohexane and mixtures of cyclohexane and n-heptane. The hydrocarbon solvent is typically supplied from a large container and may be supplied by gravity or through the use of a pump.

A supply of alkyllithium is provided to the invented system in a hydrocarbon medium, with the alkyllithium component typically present in an amount from about 10 wt % to about 90 wt % of the mixture. However, the invention is not so limited and the alkyllithium can be present in smaller or larger concentrations. The alkyllithium is provided as a solution for several reasons. First, pure alkyllithium is extremely pyrophoric, meaning that it reacts violently with water, including the moisture in air. The hydrocarbon component of the solution lowers the concentration of alkyllithium at the air interface, thereby lowering the overall reactivity of the solution with air. Further, the liquid hydrocarbon provides a medium in which the alkyllithium may be easily transported, i.e. pumped, piped, moved, or stored.

If the present invention is used in a chemical plant capable of producing alkyllithium, the supply of alkyllithium solution may result from a reactor or a storage unit associated therewith. More typically, the alkyllithium solution is supplied to a site remotely located from the production source of alkyllithium. The alkyllithium solution can be supplied to such sites in canisters from about 30 L (liters) to about 20,000 L from an alkyllithium supplier such as FMC Lithium Division, although smaller or larger sized containers can be used.

The present invention is applicable to organometallic compounds, in general, but finds particular application to alkyllithium compositions. As used herein, alkyllithium compositions are generally defined as those compositions having the formula RLi where R is from one to twelve carbons. Preferred alkyllithium compositions are methyllithium, ethyllithium, n-propyllithium, 2-propyllithium, n-butyllithium, s-butyllithium, t-butyllithium, n-hexyllithium, 2-ethylhexyllithium, 1-octyllithium, and mixtures thereof, supplied at concentrations of 10 wt % to 90 wt % hydrocarbon medium. Other organometallic compounds which may be used in accordance with the invention include lithium diisopropylamide and dibutylmagnesium.

The supply of alkyllithium solution is blended with the supply of hydrocarbon solvent. The mixing may be accomplished with a variety of mixing means. In general, most industrially known means of mixing and agitating a low-viscosity solution may be used. For instance, the mixing means may be a tank, baffled or unbaffled, having one or more impellers directing the flow of solution in either an axial or radial direction with respect to the impeller. Preferably, the mixer is a static mixer, which is a chamber having a series of stationary baffles or conduits which force the liquids to mix with themselves as they flow through the mixer. Use of the mixer ensures homogeneity of the mixture prior to downstream spectroscopic analysis. Mixing allows combination of the alkyllithium solution and the hydrocarbon stream in ratios from about 20:1 to about 1:20.

The energy for the mixing process is provided by pressure, derived from a pump or a static pressure system, such as compressed gas. Alternatively, a small pump provides increased pressure to the combined stream of alkyllithium solution and hydrocarbon solvent prior to the mixing process. It is preferred that all tanks, supply lines, and mixers of the process be kept under continuous positive pressure with nitrogen so that air is not allowed to enter the alkyllithium system through failed mechanical components or otherwise. The pressures of the liquids and the flow rates throughout the invented system may be adjusted to suit the end-user's process requirements.

After mixing, properties of the blended alkyllithium stream are quantitatively measured with spectroscopic analysis. For such analysis, the blended alkyllithium is analyzed downstream of the mixer, either by removing a small stream of the blended alkyllithium and circulating the stream through a spectroscopic cell or by directly analyzing the main blended alkyllithium stream. A spectroscopic cell is a device consisting of a light conducting component that receives light from a light source and transmits a particular or several particular wavenumbers of light through the sample and a second light-conducting component capable of receiving the transmitted wavenumbers of light after they have traveled through the sample.

In one embodiment of the invention, a portion of the blended alkyllithium stream is diverted away from the main stream and circulated through a spectroscopic cell. The diverted stream is preferably handled in a fast loop sample system that transports the sample quickly from the blended alkyllithium stream to the spectroscopic cell. Since the stream of blended alkyllithium leaving the mixer is under at least minimal pressure, the diverted stream of blended alkyllithium may simply be drawn from the main stream, circulated through the spectroscopic cell, and replaced in the main stream of blended alkyllithium. Alternatively, a small pump may be used to propel the side stream of blended alkyllithium to and/or from the spectroscopic cell.

Analysis of a diverted side stream of blended alkyllithium allows for the blended alkyllithium stream to optionally be analyzed under temperature-controlled conditions, resulting in a more accurate analysis. The spectroscopic equipment is calibrated to analyze samples at a particular temperature, typically 35° C., and variance from the calibration temperature may result in error within the readings. The main blended alkyllithium process stream typically has a reasonably consistent temperature and may be used as a point for direct analysis. However, insuring the temperature of the sample under temperature controlled conditions gives a relatively more reliable reading than a sample where temperature is not controlled within tight tolerances. After diversion from the main stream, the diverted blended alkyllithium is heated or cooled to the optimum temperature for analysis by the particular spectroscopic equipment being used. It is preferable that the spectroscopic cell and related spectroscopic equipment be maintained in a temperature controlled enclosure and that the temperature of the alkyllithium sample be optimized prior to analysis. A small heat exchanger may be used, if needed, to exchange heat between the diverted alkyllithium streams entering and exiting the temperature controlled spectroscopic analysis enclosure.

In another embodiment of the invention, a spectroscopic cell is used to analyze the properties of the blended alkyllithium directly from the flow of alkyllithium downstream of the mixer. In this arrangement, the entire stream of blended alkyllithium flows through a spectroscopic cell which is designed so that the blended alkyllithium is allowed to flow in one direction through the cell while one or more wavenumbers of light are projected by a light source from one side of the cell to the other, perpendicular or nearly perpendicular to the flow of the alkyllithium.

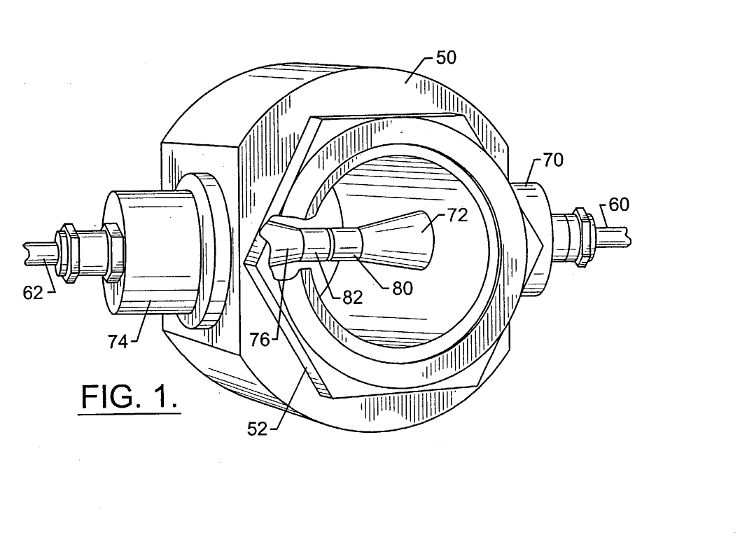

Referring to FIG. 1, a spectroscopic cell for use in analyzing an in-line flow of blended alkyllithium typically comprises a section of stainless steel pipe having walls 50 connected to the main blended alkyllithium piping system via fittings 52 downstream of the mixer. A first fiber optic element 60 is releasably connected to the side of the cell via a fiber optic fitting 70. Either the first fiber optic element 60 or an additional fiber optic element in communication with element 60 passes through the cell wall 50 and is supported within the cell by first fiber optic support 72. A second fiber optic element 62 is releasably connected to the side of the cell opposite the first fiber optic element 60 via a second fiber optic fitting 74. Either the second optic element 62 or an additional fiber optic element in communication with element 62 passes through the cell wall 50 and is supported within the cell by a second fiber optic support 76. End portions 80, 82 of the first and second fiber optic elements 60, 62 are positioned within the cell and spaced approximately 1 mm from one another. The end portions 80, 82 are preferably sapphire elements which are fixed in place within the support members 72, 76, and which are in operable communication with the fiber optic elements 60, 62. Sapphire is an exemplary material for use with analysis using infra-red (IR) wavenumbers, as the sapphire is transparent to most wavenumbers in the IR spectrum.

In operation, the blended alkyllithium flows through the spectroscopic cell and a portion of the flowing alkyllithium passes through the narrow opening left between the two end elements 80,82. Light from an IR source is transmitted through the optic cable 60, through the end element 80, and through a sample of alkyllithium, which flows through the small void between the end elements 80,82. The IR light that has passed through the sample is received by the second end element 82 and conducted through the second optic element 62 to a detector.

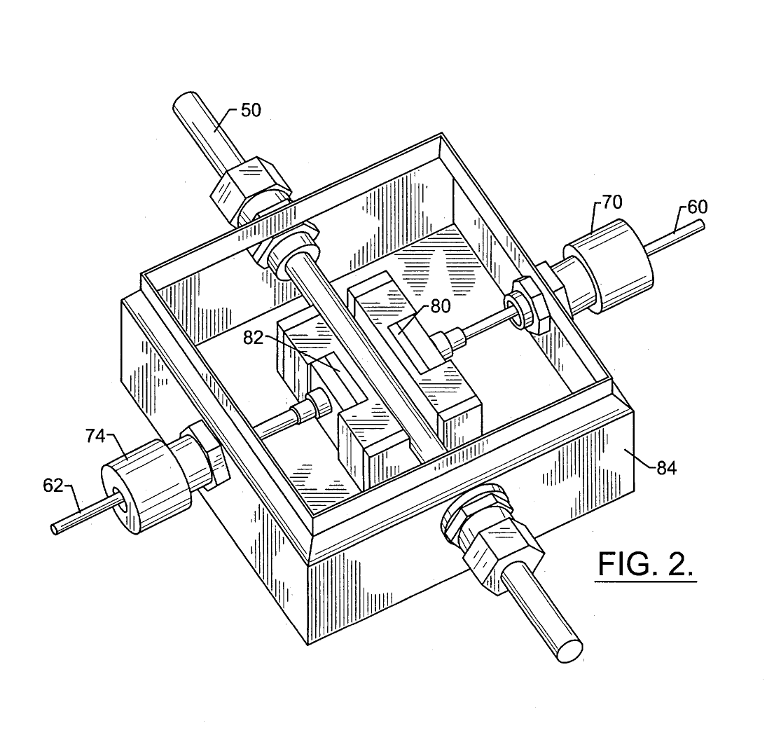

Referring to FIG. 2, a spectroscopic cell may alternatively be configured for analyzing a side stream of alkyllithium taken from the main blended stream. An extractive sample flow cell is analogous to the in-line flow cell. A small diameter tube 50 is disposed through the cell housing 84. The small diameter tube 50 carries a low volume of sampled alkyllithium from the main blended alkyllithium piping system, through the cell, and back to the main system. A fiber optic element 60 is held in place by a connector 70 attached to the cell housing 84. A second fiber optic element 62 is held in place by a connector 74 attached to the cell housing 84 opposite the first connector 70. The fiber optic elements 60,62 protrude through the walls of the cell housing 84 and converge at optical windows 80,82 which face one another from opposing sides of the flow tube 50. The windows 80,82 may form part of the wall of the flow tube 50, allowing light to be transmitted directly from one window 80, across the sample, to the second window 82. Alternatively, the optical windows 80,82 are spaced at the outside diameter of the flow tube 50 and the flow tube is constructed of a IR light transparent material in the proximity of the windows 80,82, so that light may transmitted from the first window 80, through the tube 50 wall, through the sample, through the tube 50 wall opposing the first tube 50 wall, and into the second window 82.

In operation, a low volumetric flow of blended alkyllithium is extracted from the main supply of blended alkyllithium of the process. The extracted alkyllithium flows through the flow tube 50 of the spectroscopic cell and the alkyllithium passes between the optical windows 80,82. Light from an IR source is transmitted through the optic cable 60, through the first window 80, and through the sample of alkyllithium within the pipe. The IR light that has passed through the sample is received by the second window 82 and conducted through the second optic element 62 to a detector.

The spectroscopic cells have means for manually or automatically introducing wash fluids and standardized samples into the cells. The regular use of standardized samples allows for calibration of the spectroscopic equipment.

A direct spectroscopic insertion probe, also known as an immersion probe, is a variation of the spectroscopic cell that may be used with the invented system. The insertion probe is a cell which may be inserted into a tank or process stream and which enables the analysis of fluid directly surrounding the probe. Unless otherwise specified, the insertion probe may be used in place of a standard spectroscopic cell in any of the applications described herein.

The spectroscopic cells are operatively connected to a spectrometer. A spectrometer is a device having a light source, a mechanical means for splitting or manipulating the light from the light source, and a detector that receives light and translates light into an electronic signal. The light source produces a sample of light that is split into various wavelengths by the mechanical splitting means. For simple IR spectrometry, the splitting means is often a diffraction grating. For a more complex FTIR apparatus, the splitting means encompasses a series of mirrors that move with respect to one another. Whatever light is produced from the light source, to the splitting means is transmitted to the splitting means and finally to the spectroscopic cell via a fiber optic element 60.

Manipulated light from the spectrometer is projected via fiber optic cells to a spectroscopic cell as described above. The detector of the spectrometer receives light that has been transmitted through the spectroscopic cell via an optical element. The detector is a photoelectric, or similar, device that transforms the light signals received from the optical element into an electrical signal that is representative of the characteristics of the light received by the detector. The spectrometer combines the electronic information received from the detector with information concerning the spectrum of light being transmitted, the status of the interferometer, and other data concerning the amount and type of radiation transmitted through the sample and absorbed by the detector. The compiled information is either interpreted within the spectrometer unit or is transmitted to a spectroscopic analyzer, such as a personal computer or other device that may be used to interpret the electronic data. Spectrometers are commercially available. An example of a commercially available unit is the MB160 FT-NIR unit by ABB of Quebec, Canada.

The spectroscopic information from the spectrometer is typically transmitted to a spectroscopic analyzer. The spectroscopic analyzer is a microprocessor based analytical device that interprets the raw spectroscopic data from the spectrometer and translates the information into a format that is usable for process control or understandable by a process operator. Typically, the spectroscopic analyzer is a Personal Computer loaded with appropriate software. The computer and software perform mathematical operations upon the spectroscopic data in order to develop a spectral analysis of the data. The spectroscopic analysis of most forms of spectroscopic equipment, i.e. NMR, UV-visible light, and simple IR, result in a plot of intensity of radiation versus frequency of radiation. The analyzer and associated software compare the spectrum plot with previously inputted data to determine the concentration of the components being analyzed and the identity of impurities. In the instant invention, the components being analyzed are organometallic compounds, particularly alkyllithiums, along with the solvent or solvents being used to hold the organometallic in solution. Impurities to be identified include water, alcohols, oxygen, and any other substances not normally found in the dilution process. Spectroscopic analysis units and analytic software are commercially available.

The spectrometer and spectroscopic analysis components of the invention are preferably Fourier Transform Infra-Red (FTIR) or Fourier Transform Nearlnfra- Red (FT-NIR) spectroscopy components. A typical FTIR comprises a stabilized infrared light source, an interferometer, a beam splitter, and a detector array. Instead of spatially separating the optical frequencies using a device such as a diffraction grating, the FTIR modulates all wavelengths simultaneously with distinct modulation frequencies for each wavelength. The modulation is accomplished by a variable interference effect created by separating the near infrared beam into two and then introducing a path difference before recombining the beams at the detector after passing through the sample.

The manipulated light is transmitted to the spectroscopic cell via low OH fiber optic cables. The light is transmitted from the fiber optic cable, through the sample of blended alkyllithium, and to a second fiber optic cable. The detector absorbs the IR radiation from the second optic cable, and emits an electronic signal. This electronic signal is then transmitted to an FTIR analyzer.

The electrical signal from the detector corresponds to the beam intensity of the FTIR, which is a function of the optical path difference and is called an interferogram. The analyzer performs a Fourier transform mathematical operation upon the interferogram, resulting in a calculated intensity vs. frequency spectrum that may be compared to a desired spectrum corresponding to a desired concentration of alkyllithium within the blended alkyllithium stream. An example of an analyzer for use with FTIR spectra is a Pentium™ based Personal Computer loaded with Bomem Grams/32 spectral acquisition software and PLSplus/IQ PLS algorithm modeling software, both by Thermo Galactic Industries Corporation of Salem, New Hampshire. PLS, or Partial Least Squares Regression, is the preferred method of analysis of FTIR determined spectral data. Based upon differences in the calculated spectrum and the spectrum corresponding to the previous samples used for calibration of the spectroscopic equipment, the analyzer determines the concentration of alkyllithium within the sampled stream.

Though FTIR spectroscopy is the preferred analytical tool of the invention, any spectroscopic equipment capable of quantitative analysis using wavenumbers corresponding to organometallic compounds may be used in accordance with this invention.

A controller receives an analog or digital electronic input from the analyzer that corresponds to the measured alkyllithium concentration of the blended stream. The controller compares the determined concentration of the blended alkyllithium to the desired concentration of alkyllithium that is predetermined for use with a particular process. Based upon the difference in values of the determined and desired concentrations, the control unit adjusts the feed rates of the alkyllithium source, the solvent source, or both in accordance with the input received from the analyzer. In this manner, a control loop is established whereby the concentration of the blended alkyllithium stream may be repeatedly or continuously monitored and adjusted in order to maintain a constant concentration of alkyllithium as an output from the invented system.

The light source, light splitting means, and detector is typically housed within a common unit. However, it is possible for each of the components to be housed separately. The spectrometer is in communication with the analyzer, and the analyzer is, likewise, in communication with the control apparatus. Communication is typically provided by an electronic connection. However, the term communication is simply intended to mean the transfer of data, which may be transmitted in electrical, optical, or any other form of transmitting and receiving analog or digital data known in the art.

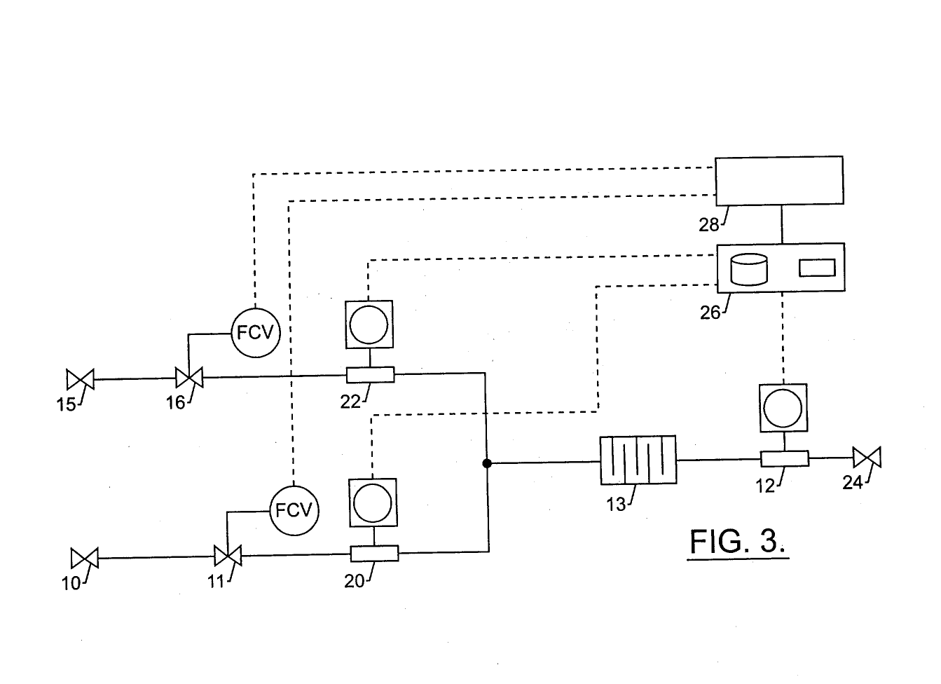

Referring to FIG. 3, one embodiment of the invention provides an in-line dilution system having an inlet 15 of alkyllithium solution in hydrocarbon medium and an inlet 10 of a hydrocarbon solvent. The stream of alkyllithium solution provided by the alkyllithium inlet 15 flows to an alkyllithium flow control valve 16. Similarly, the stream of hydrocarbon solvent provided by the hydrocarbon inlet 10 flows to a hydrocarbon flow control valve 11. After leaving the alkyllithium 16 and hydrocarbon 11 flow control valves, the respective streams are joined at or just prior to entering a mixing apparatus 13. The flow of mixed alkyllithium and solvent is transported from the mixing apparatus 13 to a blended alkyllithium outlet 24. In line with the flow of mixed alkyllithium is a FT-IR spectroscopic cell 12 for measuring the properties of the mixed alkyllithium between the mixing apparatus 13 and the blended alkyllithium outlet 24. The FT-IR spectroscopic cell 12 is optically connected with a combined FT-IR spectrometer/analyzer array 26. Based on quantitative analysis of the blended alkyllithium stream performed by the array 26, a control device 28 exerts control over the alkyllithium flow control valve 16 and/or the solvent flow control valve 11 in order to adjust the actual properties of the blended alkyllithium stream, as measured by FT-IR analyzer 26, to user defined levels.

The system optionally employs additional spectroscopic cells located in line with the alkyllithium solution feed and/or the hydrocarbon solvent feed. An alkyllithium feed spectroscopic cell 22 is optionally positioned either upstream or downstream of the alkyllithium flow control valve 16. Similarly, a solvent spectroscopic cell 20 is optionally positioned either upstream or downstream of the solvent flow control valve 11. These cells 20, 22 function in the same manner as the main spectroscopic cell 12, but may be used to provide additional information to the FT-IR analyzer array 26 in order to provide a more detailed analysis of the content of the feed streams prior to mixing. The initial concentration of alkyllithium within the alkyllithium feed stream may vary over time as a result of process conditions or conditions within the alkyllithium storage container. Similarly, the concentration or composition of the solvent feed may vary over time, particularly if the solvent feed is a recycled stream from a previous process in which it contained alkyllithium. Use of additional cells 20, 22 provides additional information to the analyzer array 26 before the information is reflected in the downstream cell 12, thereby allowing for more efficient control of the system.

Use of a solvent spectroscopic cell 20 also allows for the qualitative and quantitative analysis of impurities within the solvent stream. Spectroscopic analysis is preferably used to analyze the solvent stream for water content. The unique signature of water within the particular hydrocarbon mixture is easily recognized by an FTIR or similar spectroscopic apparatus. The water content of the solvent may be quantitatively measured and the solvent may be diverted from combination with the alkyllithium, manually or automatically, if the water content of the solvent is found to be unsafe.

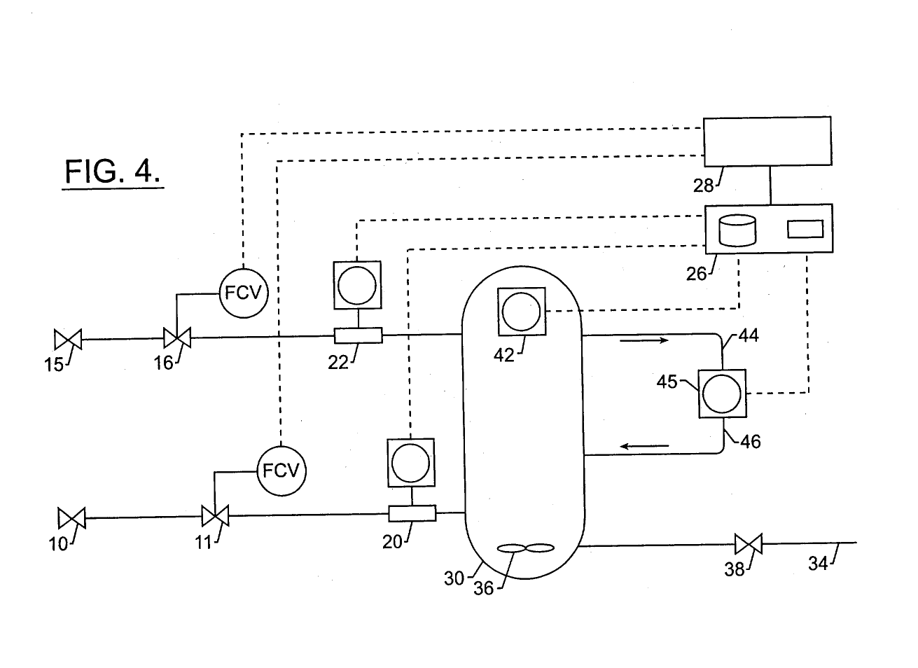

Referring to FIG. 4, an embodiment of the invention regulates the concentration of an alkyllithium solution within a stirred tank. The system has an inlet 15 of alkyllithium in a hydrocarbon medium and an inlet 10 of a hydrocarbon solvent. The stream of alkyllithium solution provided by the alkyllithium inlet 15 flows to an alkyllithium flow control valve 16. Similarly, the stream of hydrocarbon solvent provided by the hydrocarbon inlet 10 flows to a hydrocarbon flow control valve 11. Both the stream of alkyllithium and the stream of solvent flow into a stirred vessel 30. The vessel 30 is closed to the environment so as to prevent moisture from entering the vessel and, further, the vessel 30 has at least one agitator 36 therein, to agitate the alkyllithium and solvent to insure homogeneity of the solution. Blended alkyllithium is released from the vessel 30 through a blended alkyllithium outlet 34 which is selectively opened or closed by a valve 38.

Spectroscopic measurements of the contents of the vessel 30 are made with an insertion probe 42. Alternatively, spectroscopic measurements of the contents of the vessel 30 are made by feeding a sample outlet stream 44 from the vessel 30 to a spectroscopic cell 45 and then returning the stream 46 to the vessel 30. Whether the insertion probe 42 or the normal spectroscopic cell 45 are used, an optical signal is sent to the probe 42 or cell 45 from the manipulated light source of the spectrometer, and returned from the probe 42 or cell 45 to a spectrometer/analyzer array 26, which converts the optical signal into a electronic signal and converts the electronic signal into data used to calculate the concentration of alkyllithium within the vessel 30. The calculated data is sent to a control unit 28, which adjusts the alkyllithium control valve 16, the solvent control valve 11, or both the alkyllithium and solvent valves 16,11 in response to the difference in measured values of alkyllithium concentration and the desired concentration of alkyllithium.

As with the in-line dilution system, the stirred tank system optionally employs additional spectroscopic cells located in line with the alkyllithium feed and/or the solvent feed. An alkyllithium feed spectroscopic cell 22 is optionally positioned either upstream or downstream of the alkyllithium flow control valve 16. Similarly, a solvent spectroscopic cell 20 is optionally positioned either upstream or downstream of the solvent flow control valve 11. These cells 20, 22 function in the same manner as the main spectroscopic cell 12, but may be used to provide additional information to the analyzer array 26 concerning the content of the feed streams.

The components of the system may be formed from any material that is not reactive with alkyllithium compounds, and the components of the system are preferably formed of stainless steel.

All measurements, calculations, and process settings of the system may be displayed to the user via a user interface. This information may also be transmitted to a remote location via such communication means as hardwiring, telephone, radio communication, or computer networks, including the Internet. The control logic of the system is optionally adjustable from a remote location via the same communication means discussed above.

The system is advantageously constructed on a movable skid. The skid allows the system to be mobile and allows the temporary installation of the system where dilution of alkyllithium or a constant concentration of alkyllithium is required or desirable. Each of the alkyllithium inlet 15, the solvent inlet 10, and the blended butyl lithium outlet 24 are optionally connected to easily detachable fittings.

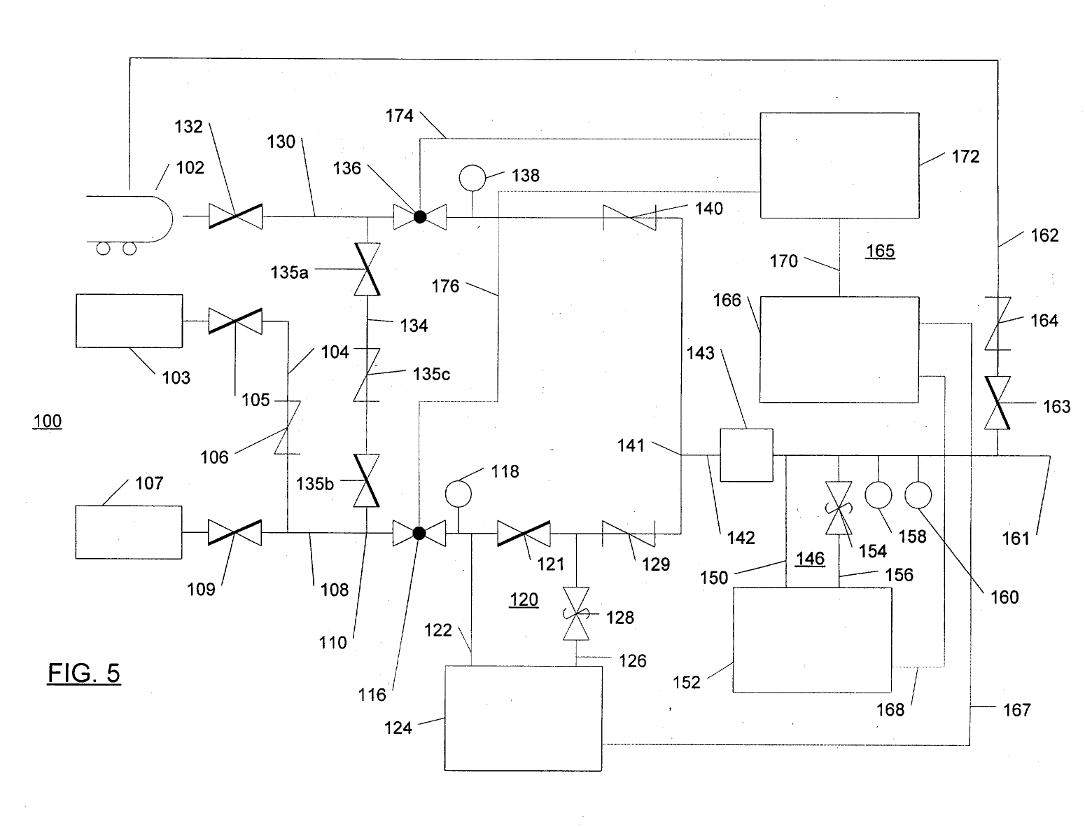

Referring now to FIG. 5, a system 100 according to the present invention that can be attached to an ISO tanker is illustrated therein. As illustrated in FIG. 5, the system 100 can be attached to an ISO tanker 102, but can also be connected to another movable or stationary source of organometallic compound. In some embodiments, the ISO tanker 102 will supply the organometallic compound (such as butyl lithium) and the other components of the system will be provided on site (eg., they may be permanent supply sources at a plant or factory). The system 100 includes three separate supply sources: the ISO tanker 102 for the organometallic compound; a nitrogen source 103; and a solvent source 107. These feed, respectively, into a nitrogen supply line 104, a solvent supply line 108, and an organometallic supply line 130. These are described in greater detail below.

The nitrogen supply line 104 is configured to supply nitrogen gas (or some other purge gas) to the system 100. The nitrogen supply line 104 includes an isolation valve 105 that can cut off the supply of nitrogen to the system 100 and a control valve 106 that can control the flow rate of nitrogen into the system 100. In ordinary operation, the isolation valve 105 is closed to prevent the passage of nitrogen into the system 100. During maintenance of the system 100, the isolation valve 105 can be opened to permit the passage of purging nitrogen into the system 100 or to conduct a pressure test on the system 100 before use.

The solvent supply line 108 includes an isolation valve 109 that can cut off the supply of solvent to the system 100. The solvent supply line 108 meets the nitrogen supply line 104 at a junction 110. A flow control valve 116 and a flow transmitter 118 that can detect the flow rate of solvent in the solvent supply line 108 are included in the solvent supply line 108 downstream of the junction 110.

A spectroscopic cell subsystem 120 is connected with the solvent supply line downstream of the flow transmitter 118. The subsystem 120 includes an inlet line 122 that lead away from the solvent supply line 108 and an outlet line 126 that returns to the solvent supply line 108. A spectroscopic cell 124 (for example, of the configuration described above in connection with FIGS. 1 and 2) spans the ends of the inlet and outlet lines 122, 126. A low flow switch 128 is located on the outlet line 126.

The solvent supply line 108 also includes a valve 121 between the inlet and outlet lines 122, 126. Another control valve 129 is positioned downstream of the subsystem 120. The solvent supply line 108 terminates at a junction 141 with the organometallic supply line 130.

Still referring to FIG. 5, the organometallic supply line 130 includes an isolation valve 132 that can be closed to isolate the organometallic supply source 102 from the line 130. A maintenance line 134 extends between the organometallic supply line 130 and the solvent supply line 108 to provide flexibility in maintaining and flushing the system 100; the maintenance line 134 includes two valves 135a, 135b that sandwich a control valve 135c. A flow control valve 136 is located downstream of the maintenance line 134, as are a flow transmitter 138 and a control valve 140.

The organometallic supply line terminates at the aforementioned junction 141 with the solvent supply line 108.

Referring once again to FIG. 5, a blended product line 142 begins at the junction 142 and terminates at an exit 161. A static mixer 143 is positioned downstream of the junction 142 and serves to mix the streams exiting the solvent supply line 108 and the organometallic supply line 130. A spectroscopic cell subsystem 146 is positioned downstream of the mixer 143. Like the subsystem 120 described above, the subsystem 146 includes inlet and outlet lines 150, 156, a spectroscopic cell 152, and a low flow switch 154. The inlet and outlet lines 150, 156 sandwich a valve 148 on the blended product line 144. A flow transmitter 158 and a pressure transmitter 160 are positioned between the outlet line 156 and the exit 161.

A flush line 162 extends between the blended product line 144 and the ISO tanker 100. A valve 163 and a control valve 164 are included in the flush line 162.

Referring still again to FIG. 5, a control system 165 includes a networker 166 and a PLC 172. The networker 166 is electrically connected with the spectroscopic cells 124, 152 by, respectively, fiber optic lines 167, 168. A signal line 170 electrically connects the networker 166 with the PLC 172. A solvent control line 176 electrically connects the PLC 172 and the flow control valve 116 found on the solvent supply line 108. Similarly, an organometallic control line electrically connects the PLC 172 and the flow control valve 136 found on the organometallic supply line 130. In some embodiments, the PLC 172 is connected to some or all of the valves, meters and indicators described above and can control their operation automatically (for example, through a pneumatic system) or through operator input.

In operation, a blended organometallic solution of a desired concentration is produced by opening the valves 109, 116, 121 and 129 on the solvent supply line 108 and the valves 132, 136 and 140 on the organometallic supply line 130 and closing the valve 105 on the nitrogen supply line 104. Solvent flows through the solvent supply line 108 to the junction 142 and into the mixer 143 (notably, solvent concentration is monitored by the spectroscopic cell 124). Organometallic material flows through the organometallic supply line 130 to the junction 142 and into the mixer 143. Blended product then flows through the blended product supply line 144 to the exit 161. Some of the blended product is diverted into the spectroscopic cell subsystem 146, wherein the concentration of organometallic material in solution is detected.

Optical signals indicative of the solution concentration from the spectroscopic cells 124, 152 is transmitted to the networker 166 via the fiber optic lines 167, 168. Signals are then transmitted to the PLC 172 via the signal line 170. Based on the concentration information gathered and the predetermined desired concentration of solution, the PLC 172 may adjust the flow control valves 116, 136 as needed by transmitting signals along the organometallic and solvent control lines 174, 176.

The system 100 also includes additional features. For example, the system 100 can automatically flush and acquire new reference spectra of the spectroscopic cells 124, 152 prior to use. Upon initialization of a blend process, the PLC 172 can automatically open the solvent supply valves 109, 116 and 129 (closing valve 121) and flush the spectroscopic cells 124, 152 with solvent. The solvent can be directed back to the ISO tanker 102 or other vessel by opening the valve 164 in the flush line 162. The PLC 172 can then close off the solvent supply line 108 by closing the valve 109 and opening the valve 105 on the nitrogen supply line 104. This enables the system 100 to purge the spectroscopic cells 124, 152 using the inert gas supply, again back to the ISO tanker 102 or an appropriate waste vessel. The PLC 172 can then initialize the networker 166 to collect reference spectra on the spectroscopic cells 124, 152 in turn. Upon each background collection the system 100 can carry out diagnostic checks on the health of the cells 124, 152. If a problem is identified the system 100 can automatically shut down and indicate maintenance is required. Once the background has been successfully obtained the system 100 can begin the desired blending operation. The automatic flush and background collection is designed to ensure no fouling of the system 100 occurs by process material and can ensure that the system 100 operates at peak performance.

Of course, the system 100 can be flushed in the manner described above at any point of operation; flushing is not limited to occurring prior to blending or to following the steps set forth above.

The system 100 can be configured to be used in a single, permanent location or to be attached to an ISO tanker (as shown) and used as an off-loading blending device. In either instance the system 100 can be mounted on a skid and can contain a varying number of the components that make up the system 100, dependant on the requirements of the user's process. A skid-mounted system 100 can contain the control hardware such as valves, flow measurement devices as well as the PLC 172 and the spectroscopic cell subsystems 120, 156. Alternatively, one or more of the spectroscopic cells can be located separate from the skid and communication between the cells and the skid is facilitated by the use of fiber optic and data cables.

When the system 100 is configured as a stand-alone system, process connections to the skid would typically comprise the organometallic source, solvent, electrical power, instrument compressed air, inert gas, and spectroscopic fiber optic and data cables. If the skid is connected to the ISO tanker 102, the organometallic supply originates from the ISO tanker 102. The PLC 172 in this configuration typically has the ability to control pressurization and venting as well as monitoring temperature, pressure and level in the ISO tanker 102. It can also allow for washing of the system's internal pipe work and optics. The washings can be returned to the ISO tanker 102 by means of the flush line 162, which is directed back to an inlet on the ISO tanker 102.

Those skilled in this art will appreciate that the system 100 can be used with continuous supply, batch, and semi-continuous supply systems.

Although the spectrometers of the invention are used primarily for quantitative analysis of the alkyllithium and solvent samples, the spectrometers may be used to obtain qualitative data as well. Qualitative analysis of the samples is preferably utilized to detect impurities within the system. For instance, the spectrometer and analyzer are easily programmed to recognize the solvent being used. If a foreign solvent were inadvertently added to the system, an alarm could be sounded. Also, the spectrometer is easily programmed to recognize water within the solvent stream. Information about the solvent stream may be obtained prior to the mixing of the solvent stream and the alkyllithium stream. If the water content of the stream is above acceptable levels, an alert may be sounded or the control system of the apparatus may simply be triggered not to allow the mixing of the contaminated solvent with the alkyllithium. Content of above 1000 ppm water within the solvent stream is considered dangerous. Content of less than about 100 ppm is preferred, and content of less than 50 ppm is typical and most preferred.

In accordance with the invention, a stream of alkyllithium solution having a consistent concentration may be produced from alkyllithium and solvent streams having varying or unknown concentrations. Further, by adjusting the control unit of the system output of user chosen concentrations of alkyllithium may be supplied from an alkyllithium storage container or from an alkyllithium production stream having a concentration higher than that desired by the end user.

In accordance with the practices of this invention, delivery concentrations of alkyllithium solution produced with the in-line system are within 0.5% of the desired concentration. Continuous blending of the alkyllithium within a vessel may be controlled within 1.0% of the desired batch concentration.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for controlling the concentration of an organometallic compound in hydrocarbon solvent, the method comprising the steps of:
supplying a flow of hydrocarbon solvent at a first flow rate;
supplying a flow of an organometallic composition containing at least one organometallic compound and at least one hydrocarbon medium, all at a second flow rate;
mixing the solvent with the organometallic composition to form a blended organometallic composition;
measuring over time the concentration of organometallic compound in said blended composition using spectroscopic analysis; and
adjusting at least one of said first and second flow rates such that the measured concentration of organometallic compound in said composition approximates a predetermined target concentration value.

2. The method of claim 1, wherein said spectroscopic analysis is selected from Fourier transform infra-red spectroscopy and Fourier transform near-infra-red spectroscopy.

3. The method of claim 1, wherein said organometallic compound is an alkyllithium.

4. The method of claim 3, wherein said alkyllithium is a compound of the formula RLi wherein R is C₁-C₁₂ alkyl or substituted alkyl.

5. The method of claim 4, wherein said alkyllithium is selected from the group consisting of methyllithium, ethyl lithium, n-propyllithium, 2-propyllithium, n-butyllithium, s-butyllithium, t-butyllithium, n-hexyllithium, 2-ethylhexyllithium, 1-octyllithium and mixtures thereof.

6. The method of claim 5, wherein said alkyllithium is butyllithium.

7. The method of claim 1, wherein said hydrocarbon solvent is selected from the group consisting of alkanes, cycloalkanes and aromatic solvents and mixtures thereof.

8. The method of claim 7, wherein said hydrocarbon solvent is cyclohexane.

9. The method of claim 1, wherein said organometallic compound is lithium diisopropylamide.

10. The method of claim 1, wherein said organometallic compound is dibutylmagnesium.

11. The method of claim 1, wherein the step of measuring the concentration of the organometallic compound in said composition occurs inline within a flow path of said composition.

12. The method of claim 1, further comprising the step of supplying said organometallic composition and said hydrocarbon solvent to a container.

13. The method of claim 12, wherein the step of measuring the concentration of the organometallic composition occurs by continuously drawing samples from the container.

14. The method of claim 1, wherein said adjusting step comprises adjusting the ratio of said first and second flow rates.

15. The method of claim 14, wherein adjusting the ratio of said first and second flow rates is accomplished by adjusting the flow rate of the organometallic composition.

16. The method of claim 14, wherein adjusting the ratio of said first and second flow rates is accomplished by adjusting the flow rate of hydrocarbon solvent.

17. The method of claim 14, wherein adjusting the ratio of said first and second flow rates is accomplished by adjusting both first and second flow rates such that the sum of the first and second flow rates remains constant.

18. The method of claim 1, wherein the solvent and the organometallic composition are mixed with a passive in-line mixer.

19. The method of claim 1, wherein the solvent and the organometallic composition are mixed with an active in-line mixer.

20. The method of claim 1, wherein the solvent and the organometallic composition are mixed in a vessel.

21. The method of claim 20, wherein the solvent and organometallic composition are continuously stirred within the vessel.

22. The method of claim 1, wherein the hydrocarbon solvent comprises a single hydrocarbon.

23. The method of claim 1, wherein the hydrocarbon solvent comprises a mixture of hydrocarbons.

24. The method of claim 1, wherein the predetermined target concentration is between about 5% wt and about 35% wt organometallic compound.

25. The method of claim 24, wherein the predetermined target concentration is between about 15% wt and about 19% wt organometallic compound.

26. The method of claim 1, wherein the organometallic composition is about 35% wt to about 90% wt alkyllithium and the balance is a hydrocarbon.

27. The method of claim 1, wherein said adjusting step comprises adjusting the ratio of said first and second flow rates such that the measured concentration of organometallic compound in said composition is within 1% wt of a predetermined target concentration value.

28. The method of claim 27, wherein said adjusting step comprises adjusting the ratio of said first and second flow rates such that the measured concentration of dilute alkyllithium is within 0.5% wt of a predetermined target concentration value.

29. The method of claim 1, further comprising the step of measuring the concentration of organometallic within the supply of the organometallic composition using spectroscopic analysis, and wherein the step of adjusting at least one of the flow rates is based upon the measured concentrations of both the organometallic compound within the supply of organometallic composition and within the blended organometallic composition.

30. The method of claim 1, further comprising the step of measuring the concentration of organometallic within the supply of the hydrocarbon solvent using spectroscopic analysis, wherein the flow of hydrocarbon solvent is a recycled stream of solvent containing residual organometallic compound, and wherein the step of adjusting at least one of the flow rates is based upon the measured concentrations of both the organometallic compound within the supply of hydrocarbon solvent and within the blended organometallic composition.

31. The method of claim 1, further comprising displaying the measured concentration value of said composition in a user readable format.

32. The method of claim 31, further comprising transmitting the measured concentration value of said composition to a location remote from the location where the value is measured.

33. The method of claim 32, wherein the concentration value is transmitted via electronic apparatus selected from telephone, local area computer network (LAN), or the Internet.

34. The method of claim 33, wherein said organometallic compound is supplied as a first hydrocarbon composition thereof having an initial concentration value of organometallic compound; and wherein said method further comprises: measuring the concentration of said organometallic compound in said first hydrocarbon composition flow, optionally displaying the measured concentration value of said first hydrocarbon composition in a user readable format; and optionally transmitting the measured concentration value of said first hydrocarbon composition to a location remote from the location where the value is measured.

35. The method of claim 1, wherein the organometallic composition is supplied from an ISO tanker.

36. The method of claim 1, further comprising the step of flushing the system with a gas prior to the supplying steps.

37. The method of claim 35, further comprising the step of introducing a portion of the blended organometallic composition into the ISO tanker.

38. A method for controlling the concentration of an alkyllithium composition, comprising the steps of:
supplying a hydrocarbon solvent;
supplying an alkyllithium;
mixing the alkyllithium with the solvent to form a blended alkyllithium composition;
measuring the concentration of the alkyllithium within said blended composition using Fourier transform infra-red spectroscopy; and
terminating the addition of said solvent, said alkyllithium, or both, to said composition when the measured concentration of the alkyllithium in said composition approximates a predetermined target concentration value.

39. The method of claim 38, wherein:
said alkyllithium is supplied as a first hydrocarbon composition thereof having an initial concentration value of alkyllithium which is greater than said predetermined target concentration; and
said mixing step comprises adding said hydrocarbon solvent to said first composition having an initial concentration value.

40. An apparatus for controlling the concentration of an organometallic compound in hydrocarbon solvent, the apparatus comprising:
a hydrocarbon solvent inlet, having a first valve in-line therewith;
an organometallic compound inlet, having a second valve in-line therewith;
a mixer in fluid communication with both the hydrocarbon solvent inlet and the organometallic compound inlet;
an organometallic/hydrocarbon composition outlet in fluid communication with the mixer;
a spectrometer having an input in optical communication with said composition outlet;
an spectroscopic analyzer in communication with said spectrometer; and
a control unit in communication with analyzer and operatively connected to at least one of said first and said second valves.

41. The apparatus of claim 40, wherein said spectrometer is selected from a Fourier transform infra-red spectroscopy (FTIR) apparatus and Fourier transform near-infra-red spectroscopy (FT-NIR) apparatus.

42. The apparatus of claim 41, wherein the spectrometer further comprises inputs in optical communication with the hydrocarbon solvent inlet and the organometallic compound inlet.

43. The apparatus of claim 40, wherein the mixer is a passive mixing device.

44. The apparatus of claim 40, wherein the mixer is an active mixing device.

45. The apparatus of claim 40, wherein the mixer is a vessel.

46. The apparatus of claim 40, further comprising a data communication device electronically connected to the spectroscopic analyzer, for electronically transmitting information to a remote location.

47. The apparatus of claim 40, further comprising a display terminal connected to said spectroscopic analyzer.

48. The apparatus of claim 40, wherein said spectroscopic analyzer and said control unit are contained within a single enclosure.

49. The apparatus of claim 48, wherein said enclosure is temperature controlled.

50. The apparatus of claim 40, further comprising a flush line downstream of and in fluid communication with the mixer, the flush line being configured to introduce blended organometallic compound and solvent into the organometallic compound inlet.

51. The apparatus of claim 40, further comprising a gas line having a third valve in-line therewith and in fluid communication with at least one of the hydrocarbon solvent inlet and the organometallic compound inlet.

52. The apparatus of claim 40, further comprising a skid to which the hydrocarbon solvent inlet, the organometallic compound inlet, the mixer, the organometallic/hydrocarbon composition outlet, the spectrometer, the spectroscopic analyzer and the control unit are mounted.
